(19) United States
(12) Patent Application Publication
(10) Pub. No.: US 2008/0114530 A1
(43) Pub. Date: May 15, 2008

(54) Thin client intelligent transportation system and method for use therein

(76) Inventors: Gregory C. Petrisor, Los Angeles, CA (US); Ryan A. Perdue, Venice, CA (US); William C. Elkington, Cedar Rapids, IA (US)

Correspondence Address: Scot A. Reader, Suite 228, 1320 Pearl Street, Boulder, CO, 80302, US

(21) Appl. No.: 11/977,928

(22) Filed: Oct. 26, 2007

Related U.S. Application Data
(60) Provisional application No. 60/854,791, filed on Oct. 27, 2006.

(51) Int. Cl. G08G 1/00

(52) U.S. Cl. 701/117

(57) ABSTRACT

A thin client intelligent transportation system wherein geospatial roadmaps and map matching systems are maintained in roadside nodes and are more fully exploited. The thin client approach offers significant advantages over thick client approaches that rely on on-vehicle maps and map matching systems, including reduced complexity of on-board equipment and elimination of map integrity issues. The thin client approach also offers significant advantages over systems wherein the vehicle is required to access maps and map matching systems in real-time from a remote data center, including the ability to meet the low latency requirements for many vehicle safety applications. The present invention in some embodiments has added advantages in that it exploits roadside maps and map matching systems in revenue generating applications that are not directly related to passenger safety.

### CROSS-REFERENCE TO RELATED APPLICATION(S)

This application claims priority benefits under 35 U.S.C. 119(e) of U.S. Provisional Patent Application No. 60/854,791, filed on Oct. 27, 2006, the contents of which are incorporated herein by reference.

### BACKGROUND OF THE INVENTION

The present invention relates to a thin client intelligent transportation system (ITS) and, more particularly, to an ITS in which geoposition-to-road position resolution is provided by roadside nodes to improve overall system performance.

Considerable research and development have been performed on ITS safety systems designed to reduce vehicle crashes caused by unsafe driving maneuvers at intersections, red light and stop sign running, unsafe lane changes, rear-end collisions and accidental lane and road departures due to excessive vehicular speeds in curves, drowsy, inattentive or distracted drivers, and the like. ITS safety systems to date have focused mainly on autonomous vehicle-mounted sensor and warning systems, infrastructure sensors, infrastructure warning signage and adaptive signal control.

For example, known vehicle-based ITS safety systems include lane and road departure warning systems that track lane markers with on-vehicle video cameras in order to warn drivers about impending inadvertent lane and road departures and in some cases prevent departures from occurring through automatic brake application and/or steering correction. Other examples of known vehicle-based ITS safety systems include advanced automatic cruise control and collision warning/prevention systems that utilize on-vehicle radar, LIDAR, cameras and other sensors to prevent rear-end and lane change collisions. All of these systems add considerable cost and complexity to the vehicle. Moreover, vehicle-based systems that rely on video capture do not perform well when lane dividers are obscured by water, snow, or debris on the roadway or by fog, snow, glare, dust, smoke or other atmospheric conditions.

ITS safety systems that are strictly infrastructure-based, such as intersection collision avoidance systems, have been shown to have little impact on inattentive and distracted drivers because such drivers usually do not notice roadside warning signs. The infrastructure required to deploy these systems is also complex and high cost. For example, an intersection collision avoidance system may require installation of cameras and radar around the intersection, a roadside processing unit and an active roadside warning sign.

Recent research and development have focused on Advanced Driver Assistance systems (ADAS), Vehicle Infrastructure Cooperation (VIC) and Vehicle Infrastructure Integration (VII). Known ADAS systems rely on complex, autonomous and tightly integrated on-vehicle sensors and road position resolution systems, that is, thick clients, to provide drivers with curve-overspeed warnings, lane/road departure warnings, signal/stop sign violation warnings and collision prevention warnings, among other functions. VIC and VII systems also usually rely on complex on-vehicle equipment but integrate into the system wireless communications between vehicles, and between vehicles and the infrastructure. These approaches enable vehicles to serve as probes that detect and report dangerous conditions to drivers in the form of warnings, to vehicles for automatic preemptive responses and to the infrastructure for corrective actions.

A conventional thick client ITS safety system is shown in FIGS. 1 and 2. The thick client ITS safety system relies on on-vehicle GPS systems and geoposition-to-road position mapping systems to provide drivers with curve-overspeed warnings, lane/road departure warnings, signal/stop sign violation warnings, collision prevention warnings, and the like. Updates to the mapping system are uploaded to the vehicle from a map server operating at a remote location. In FIG. 1, for example, mobile thick client nodes 100 (e.g. vehicles) on a road are shown communicatively coupled with one or more local fixed nodes 105 via one or more external connectivity nodes 103 installed at roadside. The local fixed nodes 105 are also communicatively coupled with one or more remote fixed nodes 107 operating at a remote location. Mobile thick nodes 100 communicate with each other over wireless communication links 101 and communicate with external connectivity nodes 103 over one or more wireless communication links 102. External connectivity nodes 103 communicate with local fixed nodes 105 over one or more wired or wireless roadside networks 104. External connectivity nodes 103 communicate with remote nodes 107 over one or more wired or wireless backhaul networks 106.

In FIG. 2, major subsystems of the thick client ITS safety system are shown to include on-board equipment (OBE) 210 installed on mobile nodes 100, roadside equipment (RSE) 220 installed on external connectivity nodes 103 and/or local fixed nodes 105 and a network operations center (NOC) 230 installed on one or more remote fixed nodes 107. On OBE 210, geoposition (in terms of latitude, longitude and elevation), velocity vector and time of day are determined from signals received from satellite systems 200 such as GPS or other Global Navigation Satellite Systems (GNSS) (e.g. GLONAS, Galileo) and applied. More particularly, a GPS antenna on OBE 210 picks up signals and feeds them to a GPS receiver which processes received GPS signals to determine geoposition, velocity vector and time of day. Resulting information is fed to a precision local geoposition calculation system for added precision. An antenna connected to a local communication transceiver exchanges information wirelessly with other mobile nodes 100 (e.g. other OBE) and RSE 220. For example, a local communication transceiver may receive from RSE 220 and feed to the precision local geoposition calculation system GPS differential correction signals for integration with information received from the GPS receiver in order to refine the geoposition. The refined geoposition is fed to a map matching system that compares the refined geoposition to a digital map database to determine the road position (e.g. roadway, lone) of the one of mobile nodes 100 on which OBE 210 is installed, which is then made available to an application processor. Additionally, other information received from other mobile nodes 100 and RSE 220 may be fed from the local communication transceiver to the application processor to deliver on-vehicle application services. For example, road positions of other mobile nodes 100 can be determined with the aid of the map matching system and compared with the road position of the one of mobile nodes 100 on which OBE 210 is located. Then, road positions of other mobile nodes 100, warnings of dangerous conditions and other useful information may be communicated by the application processor to a driver in visual or audible form via a passenger interface. The application processor may also receive vehicle sensor, condition, and diagnostic information from a body chassis system via a vehicle services system. In addition, the application processor may in certain cases control vehicle functions, for example, maneuver the vehicle, by sending commands to the vehicle services system.

On RSE 220, a local communication transceiver receives signals from mobile nodes 100 via an antenna and feeds them to an application processor. The application processor also receives traffic signal status and program information from a local safety processor via an I/O controller and router. Additionally, a GPS receiver receives GPS signals via an antenna. GPS receiver also outputs information to the application processor to support local applications such as differential corrections. The GPS receiver outputs information to NOC 230 via router 243 to support remote applications such differential corrections. NOC 230 controls the traffic signal by programming the signal controller via the router, I/O controller and local safety processor. RSE 220 provides OBE 210 with traffic signal phase change information by transmitting signals from the local communication transceiver on RSE 220 to the local communication transceiver on OBE 210. The application processor on OBE 210 can apply the traffic signal phase change information received from RSE 220 to determine possible red light violations.

NOC 230 exchanges information directly with RSE 220 and indirectly with OBE 210. NOC 230 has a map server and master map database that upload map data and map matching software updates to OBE 210 via RSE 220. NOC 230 also has a differential correction server and other application servers that supply services to OBE 210 via RSE 220 and also supply services to external users.

The requirement in this conventional ITS safety system to install maps and map matching software on mobile nodes 100 has several disadvantages. On-vehicle maps and map matching software create thick clients that add cost and complexity to vehicles and also add networking complexity to ensure the maps and map matching software on the vehicles is always current. Moreover, this conventional ITS safety system does not fully exploit its maps and map matching systems, for example, does not apply them in certain revenue generating applications that are not directly related to passenger safety. On the other hand, an alternative ITS system that would require vehicles to access maps or map matching software on a remote NOC in real-time would introduce latency into the system that would be unacceptable for many vehicle safety applications.

### SUMMARY OF THE INVENTION

The present invention, in a basic feature, provides a thin client ITS wherein geospatial roadmaps and map matching systems are maintained in roadside nodes and are more fully exploited. This thin client approach offers significant advantages over thick client approaches that rely on on-vehicle maps and map matching systems, including reduced complexity of on-board equipment and elimination of map integrity issues. The thin client approach also offers significant advantages over systems wherein the vehicle is required to access maps and map matching systems in real-time from a remote data center, including the ability to meet the low latency requirements for many vehicle safety applications. The present invention in some embodiments has added advantages in that it exploits roadside maps and map matching systems in revenue generating applications that are not directly related to passenger safety.

In one aspect of the invention, a method for intelligent traffic management comprises the steps of receiving Global Navigation Satellite System (GNSS) signals on a mobile client node, determining position information on the mobile client node based at least in part on the GNSS signals, transmitting the position information to a roadside system, determining on the roadside system a road position of the mobile client node based at least in part on the position information and geospatial roadmap data stored on the roadside system and generating an application result based at least in part on the road position.

In some embodiments, the method further comprises the step of transmitting the application result to the mobile client node.

In some embodiments, the method further comprises the step of transmitting the application result to a local traffic management node.

In some embodiments, the position information comprises a geoposition.

In some embodiments, the step of generating an application result comprises generating one or more of tolling information, intersection safety information, curve safety information, ramp metering information, traveler advisement information, advertising information or insurance rate information.

In some embodiments, the step of transmitting an application result comprises transmitting on or more of a driver warning, a vehicle maneuver command, information adapted for use in a system integrity check, tolling information or advertising information.

In another aspect of the invention, a thin client intelligent transportation system comprises at least one mobile client node, a roadside system comprising at least one roadside node and a wireless network communicatively coupling the mobile client node and the roadside system, wherein the mobile client node is adapted to transmit position information to the roadside system via the wireless network, receive an application result from the roadside system generated based at least in part on the position information and geospatial roadmap data stored on the roadside system and take action based at least in part on the application result.

In another aspect of the invention, a roadside system comprises a wireless communication interface, a geospatial roadmap database and a processing element communicatively coupled with the wireless communication interface and the geospatial roadmap database, wherein the processing element is adapted to determine a road position of a mobile client node based at least in part on position information received from the mobile client node via the wireless communication interface and geospatial roadmap data from the geospatial roadmap database.

In some embodiments, the processing element is further adapted to transmit to the mobile client node via the wireless communication interface an application result generated based at least in part on the road position.

In some embodiments, the roadside system further comprises a second communication interface adapted to communicatively couple the roadside system with a local traffic management system and the processing element is further adapted to transmit to the local traffic management system an application result generated based at least in part on the position.

In some embodiments, the roadside system further comprises a third communication interface adapted to communicatively couple the roadside system with a remote data center and the processing element is further adapted to transmit to the remote data center the position for processing at the remote data center.

In some embodiments, the remote data center is adapted to transmit to the roadside system via the third communication interface an update to at least one of the geospatial roadmap database or map matching software executable by the processing element.

In some embodiments, the roadside system further comprises a GNSS receiver wherein the processing element is adapted to determine the road position based further in part on position information received from the GNSS receiver.

In another aspect of the invention, a mobile client node comprises a GNSS receiver, a wireless communication interface and a processing element communicatively coupled with the GNSS receiver and the wireless communication interface, wherein the processing element is adapted to determine position information based at least in part on information received from the GNSS receiver and transmit the position information to a roadside system via the wireless communication interface, and in response to the position information receive an application result from the roadside system via the wireless communication interface.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a prior art thick client ITS safety system.

FIG. 2 shows major subsystems of a prior art thick client ITS safety system.

FIG. 3 shows a thin client ITS in some embodiments of the invention.

FIG. 4 shows thin client on-board equipment (OBE) in some embodiments of the invention.

FIG. 5 shows roadside equipment (RSE) in some embodiments of the invention.

FIG. 6 shows generic ITS method steps performed by RSE in some embodiments of the invention.

FIG. 7A shows generic ITS transmit mode method steps performed by OBE some embodiments of the invention.

FIG. 7B shows generic ITS receive mode method steps performed by OBE some embodiments of the invention.

FIG. 8 shows a high occupancy toll (HOT) lane tolling application method in some embodiments of the invention.

FIG. 9 shows an intersection safety application method in some embodiments of the invention.

FIG. 10 shows a curve safety application method in some embodiments of the invention.

FIG. 11 shows a ramp meter application method in some embodiments of the invention.

FIG. 12 shows a traveler advisement application method in some embodiments of the invention.

FIG. 13 shows a progressive insurance application method in some embodiments of the invention.

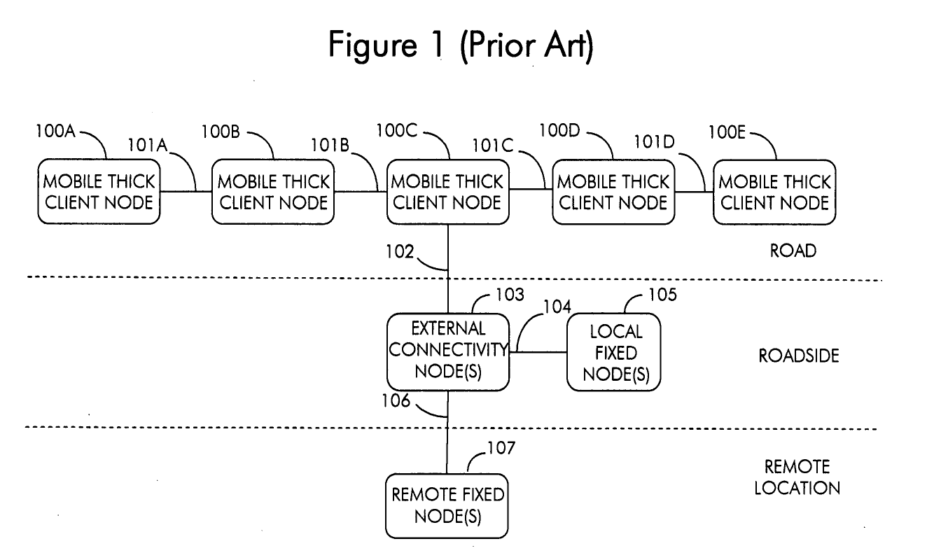

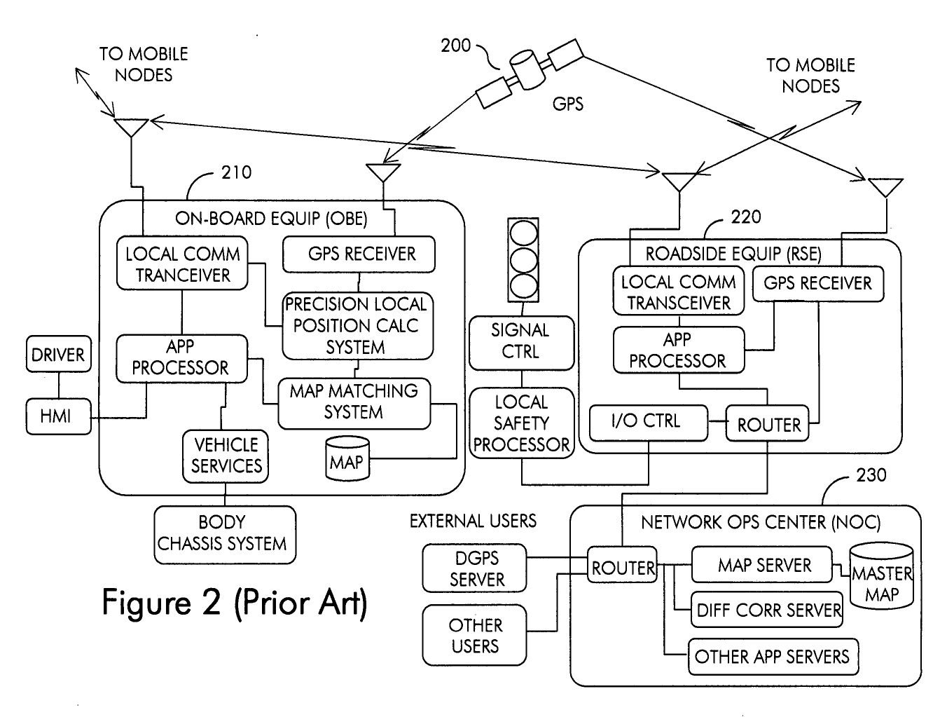

### DETAILED DESCRIPTION OF THE PREFERRED EMBODIMENT

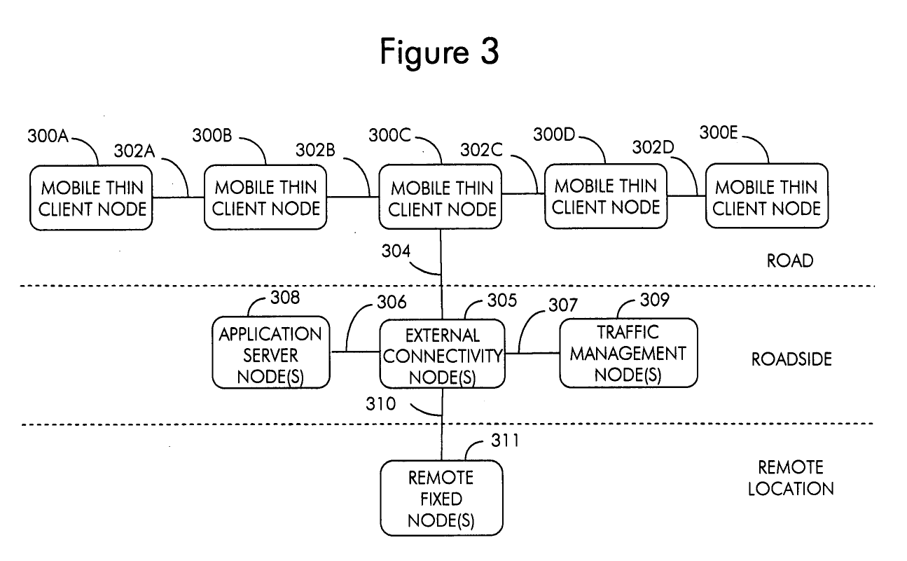

FIG. 3 shows a thin client intelligent transportation system (ITS) in which geoposition-to-road position resolution is provided by roadside nodes to improve overall system performance. In the illustrated system, mobile thin client nodes 300, such as cars, trucks, buses, motorcycles, bicycles or other vehicles that utilize roads, include on-vehicle wireless communications capability, on-vehicle geopositioning capability and on-vehicle driver notification capability. Mobile thin client nodes 300 determine their geoposition, including latitude, longitude and elevation, and transmit it to other mobile thin client nodes 300 on the road through a wireless communication link 302. Mobile thin client nodes 300 also transmit their geoposition to one or more external connectivity nodes 305 at roadside through a wireless communication link 304.

It will be appreciated that the present ITS may also include one or more mobile thick client nodes, which may be cars, trucks, buses, motorcycles, bicycles or other vehicles that utilize the road and include on-vehicle wireless communication capability, geopositioning capability, a digital geospatial roadmap database and map matching capability. Such mobile thick client nodes, where extant, determine their geoposition, including latitude, longitude and elevation, and match the geoposition to a road position using their on-vehicle databases. Such mobile thick client nodes, where extant, may also transmit their geopositions to mobile thin client nodes 300 and to one or more external connectivity nodes 305 at roadside.

In some embodiments, mobile thin client nodes 300 also determine and transmit to one or more external connectivity nodes 305 at roadside their velocity vectors along with their geopositions. More generally, mobile thin client nodes 300 may transmit to one or more external connectivity nodes 305 at roadside one or more of the following: absolute or relative position and time information, absolute or relative velocity information, acceleration information, satellite pseudo-range or phase information, GNSS waveform information, vehicle envelope information or GNSS antenna location information.

One or more application server nodes 308 receive geopositions of mobile thin client nodes 300 via one or more external connectivity nodes 305 and roadside network link 306 and match geopositions to road positions using a digital geospatial roadmap databases maintained on application server nodes 308. In addition, application server nodes 308 run applications that determine whether there are passenger safety concerns involving one or more of mobile thin client nodes 300. In some embodiments, if a safety concern is identified, application server nodes 308 issue warnings to drivers of mobile thin client nodes 300 via external connectivity nodes 305 and wireless links 304. In other embodiments, application server nodes 308 issue commands to mobile thin client nodes 300 via external connectivity nodes 305 and wireless links 304 causing mobile thin client nodes 300 to take automatic safety maneuvers (e.g. steering, braking). In addition, application server nodes 308 may transmit to nodes 300 information generated by applications that is not directly related to safety, such as tolling, ramp metering, traveler advisement or advertising information, or information that is adapted for application in a system integrity check.

One or more traffic management nodes 309 store state information for traffic signals and provide state information to application server nodes 308 for use by safety applications to assess risks that approaching mobile thin client nodes 300 will violate a traffic signal. Application server nodes 308 may transmit signal violation warnings to mobile thin client nodes 300 that have a high probability of violating traffic signals so that drivers are advised and can take preventative action. In some embodiments, application server nodes 308 may in addition or in lieu of warnings transmit commands to mobile thin client nodes 300 causing nodes 300 to take automatic preventative maneuvers (e.g. braking). Traffic management nodes 309 connect to external connectivity nodes 305 over roadside network 307. Traffic management nodes 309 may also store information for ramp meters, meteorological sensors or other roadside sensors and transmit at least some of the information to application server nodes 308.

One or more remote nodes 311 communicate with external connectivity nodes 305 over backhaul network 310. Remote nodes 311 transmit to mobile thin client nodes 300 information such as local traffic information, road condition information and weather-related information. Remote nodes 311 also transmit to application server nodes 308 updates to digital geospatial roadmap database and map matching software maintained on application server nodes 308. For their part, applications server nodes 308 transmit to remote nodes 311 local traffic information. For example, application server nodes 308 may determine the state of local ramp traffic or road traffic from geoposition information received from mobile thin client nodes 300 and transmit the local traffic information to remote nodes 311. Remote nodes 311 may then apply the local traffic information by, for example, changing the timing of local traffic signals and/or local ramp meters through communication with traffic management nodes 309 and/or generating traveler advisements for delivery to mobile thin client nodes 300.

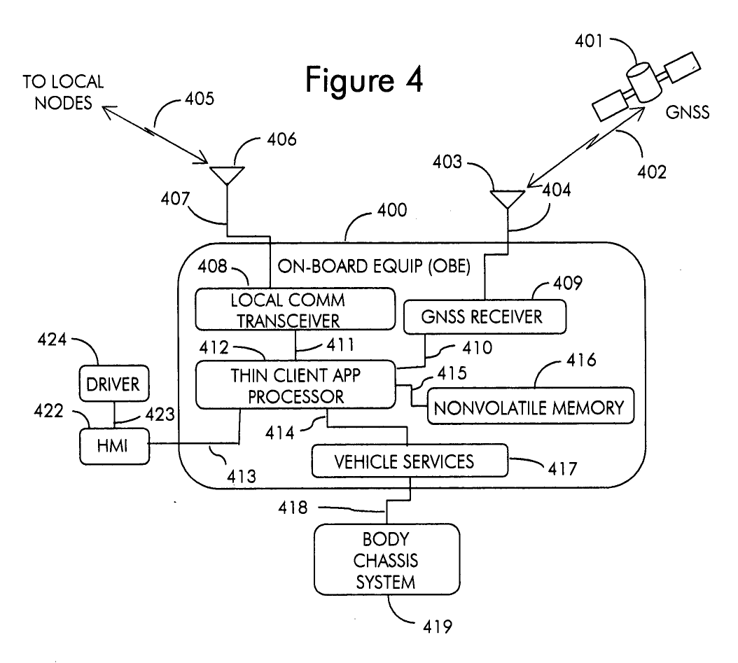

FIG. 4 shows thin client on-board equipment (OBE) 400 in some embodiments of the invention. Thin client OBE 400 is installed on mobile thin client nodes 300. OBE 400 includes a local communication transceiver 408, a Global Navigation Satellite System (GNSS) receiver 409 for receiving signals from GNSS satellites 401 over a wireless link 402 and calculating the geoposition of the one of nodes 300 on which GNSS receiver 409 is installed. A GNSS antenna 403 receives GNSS signals 402 and relays signals to GNSS receiver 409 over an antenna interface link 404. Examples of GNSS constellations whose signals may be used by GNSS receiver 409 to calculate geoposition are the U.S. Global Positioning System (GPS), the Russian GLONAS system, and the European Galileo system. GNSS receiver 409 may also receive and apply signals from pseudolites, which are non-satellite transmitters whose geoposition is known precisely and can be used to increase the accuracy of calculations made by GNSS receiver 409 relative to calculations based only on signals from GNSS satellites. OBE 400 also includes a thin client application processor 412 for processing information for delivery via a communication link 413 to a human-machine interface (HMI) 422, which may include a light emitting diode (LED) display, liquid crystal display (LCD) and/or sound-generation equipment such as a loudspeaker capable of reproducing synthetic or actual human voice. HMI 422 communicates output to a driver 424 of node 300 so that he or she may be provided safety, traffic, commercial, and other kinds of information on which driver 424 may or may not take action. In addition, OBE 400 has a further communication link 414 to vehicle services 417 which receive information from body chassis system 419 and may control elements of body chassis system 419 over communication link 418. Information received from body chassis system 419 includes braking information, vehicle kinematic information, acceleration information, pitch and yaw information and wheel position information. In addition, OBE 400 has a non-volatile memory 416 that is used by application processor 412 via communication link 415 to read and write application processing interim or final results prior to communication to the driver 424 or to other local nodes, such as other ones of mobile thin client nodes 300 and external connectivity nodes 305, through a wireless link 405. Application processor 412 also has a communication link 411 to local communication transceiver 408. Application processor 412 may process information received and for transmission via local communication transceiver 408, communication links 407, 411 and a communication antenna 406 from and to local nodes via wireless link 405.

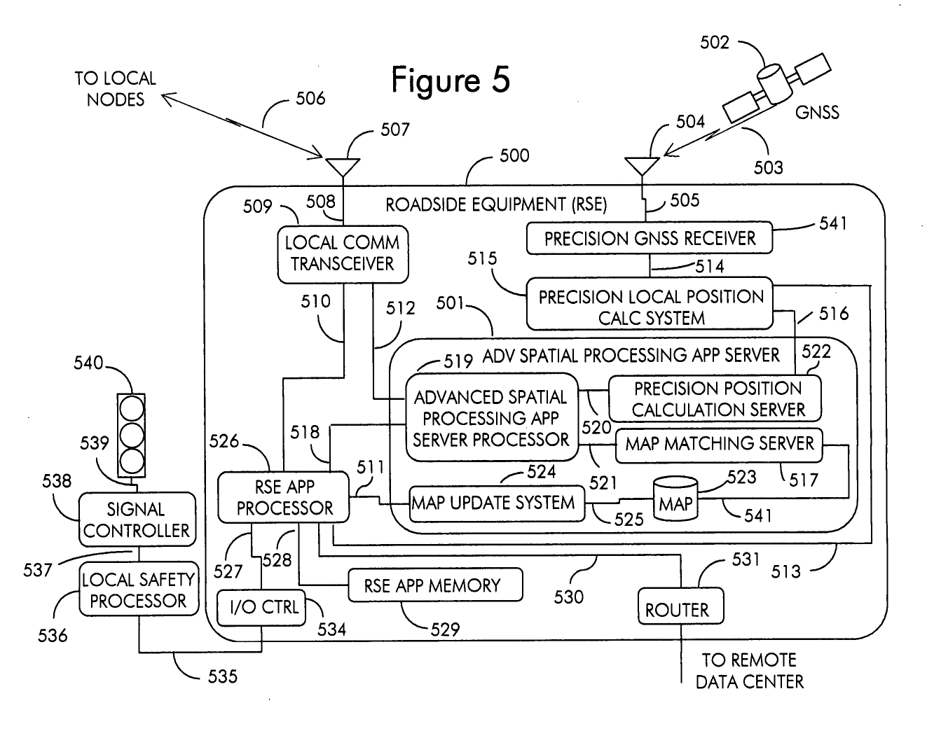

FIG. 5 shows roadside equipment (RSE) 500 in some embodiments of the invention. RSE 500 is installed at the side of a road. RSE 500 is installed across one or more external connectivity nodes 305 and/or one or more application server nodes 308. RSE 500 includes an application server 501 that supports safety and other applications for mobile thin client nodes 300 through communication over a wireless link 506. RSE 500 receives from GNSS satellites 502 GNSS signals from which time of day, geoposition, velocity vector and other information may be determined. The signals are communicated over a GNSS wireless link 503 through a GNSS antenna 504 and an antenna to receiver interface 505 to a precision GNSS receiver 541, where the geoposition of RSE 500 is determined. The geoposition is fed into a precision local position calculation system 515 through communication link 514 where system 515 applies correction information such as time, ephemeras, tropospheric, ionospheric and other correction information supplied by a remote data center through a router 531 and RSE application processor 526. Router 531 connects to the RSE application processor 526 over communication link 530. RSE application processor 526 connects to precision local position calculation system 515 via communication link 513. Precision local position calculation system 515 calculates a corrected and highly precise geoposition for RSE 500 that is transmitted along with other positioning information via communication link 516 to precision position calculation server 522. Precision position calculation server 522 computes geopositions of ones of mobile thin client nodes 300 and returns these positions to an advanced spatial processing application server processor 519 over communication link 520. Precision position calculation server 522 computes these geopositions by combining positioning information received from precision local position calculation system 515 with positioning information received from ones of mobile nodes 300, 301 through application server processor 519 over communication link 520. Application server processor 519 transmits the geopositions returned from precision position calculation server 522 to a map matching server 517 over communication link 521. Map matching server 517 resolves the geopositions to road positions by accessing over communication link 541 geospatial roadmap data stored in a geospatial roadmap database 523 to produce map matching results that are returned to application server processor 519. Application server processor 519 then applies the map matching results to determine, among other things, the relative safety of mobile thin client nodes 300.

Geospatial roadmap database 523 stores attributes for different geopositions on roads, such as road name, lanes, on-ramps, off-ramps, intersections, speed limits, traffic signals, stop signs, overpasses, underpasses, the radius of curves, road material (e.g. gravel, concrete, asphalt), road condition and mile markers. Map matching server 517 searches database 523 for matches for the calculated geopositions of mobile thin client nodes 300. Map matching server 517 supplies match information to application server processor 519 via communication link 521 and application server processor 519 assesses for safety risks the kinematics of mobile thin client nodes 300 in relation to one another and in relation to road characteristics. If there are unacceptable safety risks, application server processor 519 generates and transmits to at-risk ones of nodes 300 via communication link 512, local communication transceiver 509, antenna to transceiver interface 508, antenna 507 and wireless link 506 a warning identifying the safety risk. In some embodiments, different warnings may be issued to nodes 300, 301 depending on risk level. RSE application processor 526 takes state input from a signal controller 538 which tracks the dynamics of a traffic signal 540 via a communication link 539. Signal controller 538 furnishes this state information to RSE application processor 526 via a communication link 537, a local safety processor 536, a communication link 535, an I/O Controller 534 and a communication link 527. In addition, corrected geoposition information for nodes 300 is provided to RSE application processor 526 by precision local position calculation system 515 via link 513 which forwards the information to application server processor 519 across communication link 518. Application server processor 519 uses both information sets and inferences about the dynamics of nodes 300 to determine the relative safety of ones of nodes 300 as they approach traffic signal 540. Application server processor 519 then issues warnings tailored to individual ones of nodes 300 through communication link 510, local communication transceiver 509 and across wireless link 506 if the road position and dynamics of individual ones of nodes 300, 301 indicates that the node may violate the direction of traffic signal 540.

Road information in geospatial roadmap database 523 is updated through transmissions from a remote data center to a map update system 524 via router 531, communication link 530, RSE application processor 526 and communication link 511. When map update system 524 receives an update from a remote data center, map update system 524 checks for differences between the map data in the update and the map data stored in database 523 and replaces obsolete data using interface 525. Additionally, a remote data center updates map matching software running on map matching server 517.

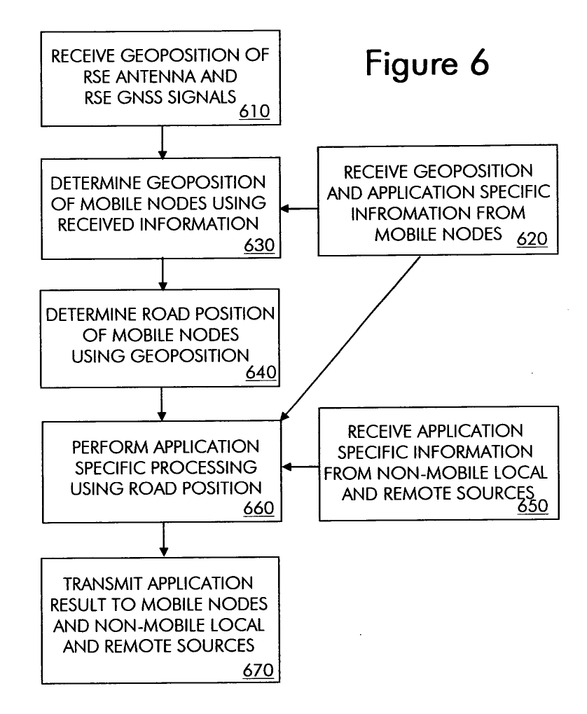

FIG. 6 shows generic ITS method steps performed by RSE 500 in some embodiments of the invention. In the generic method, RSE 500 receives GNSS signals on GNSS receiver 511 and a highly accurate absolute position of the RSE antenna (610). RSE 500 also receives positioning information and application specific information from mobile thin client nodes 300 (620). From the received information, RSE 500 estimates the absolute geoposition of mobile thin client nodes 300 (630). RSE 500 applies the geoposition to match mobile thin client nodes 300 to a road position using a database 523 stored locally on RSE 500 (640). RSE 500 then performs application specific processing (660) using the determined road position, application specific information received from mobile thin client nodes (620) and application specific information received from non-mobile local and/or remote sources (e.g. traffic management nodes 309, remote fixed nodes 311) (650). RSE 500 then transmits to mobile thin client nodes 300 and/or non-mobile local and/or remote sources application specific information (e.g. an application result) (670). RSE 500 preferably repeats steps 630, 640, 660 in a continual loop.

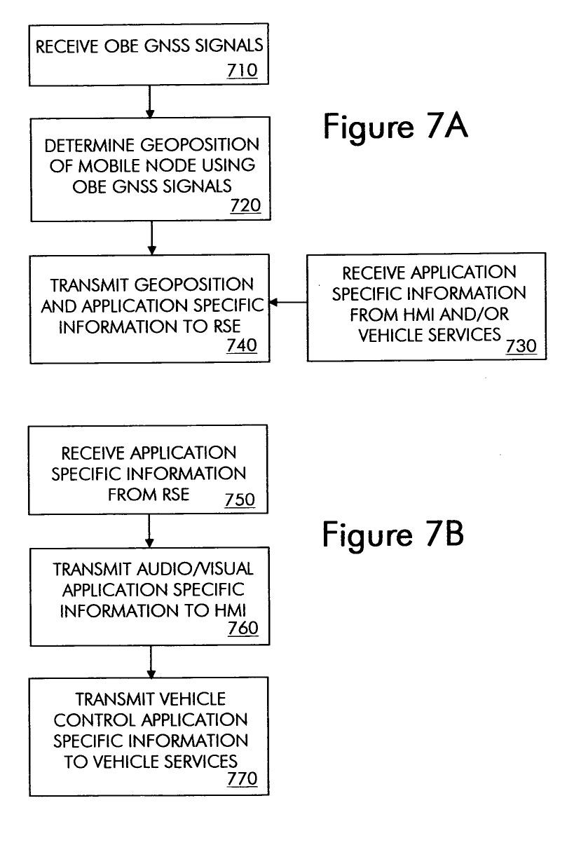

FIG. 7A shows generic ITS method transmit mode steps performed by OBE 400 in some embodiments of the invention. In transmit mode, OBE 400 receives GNSS signals on GNSS receiver 409 (710) and determines using the GNSS signals the geoposition of the one of mobile thin client nodes 300 on which OBE 400 is installed (720). OBE 400 also receives application specific information from HMI 422 and/or vehicle services 417 that is destined for RSE 500 (730). OBE 400 transmits the geoposition and application specific information to RSE 500 (930). If no connection to RSE 500 is available, OBE 400 stores the geoposition and application specific in a temporary buffer.

FIG. 7B shows generic ITS method receive mode steps performed by OBE 400 in some embodiments of the invention. In receive mode, OBE 400 receives application specific information (e.g. an application result) from RSE 500 (750). If the application specific information is audio and/or visual information the information is transmitted to HMI 422 for outputting (760). If the application specific information is vehicle control information the information is transmitted to vehicle services 417 (770).

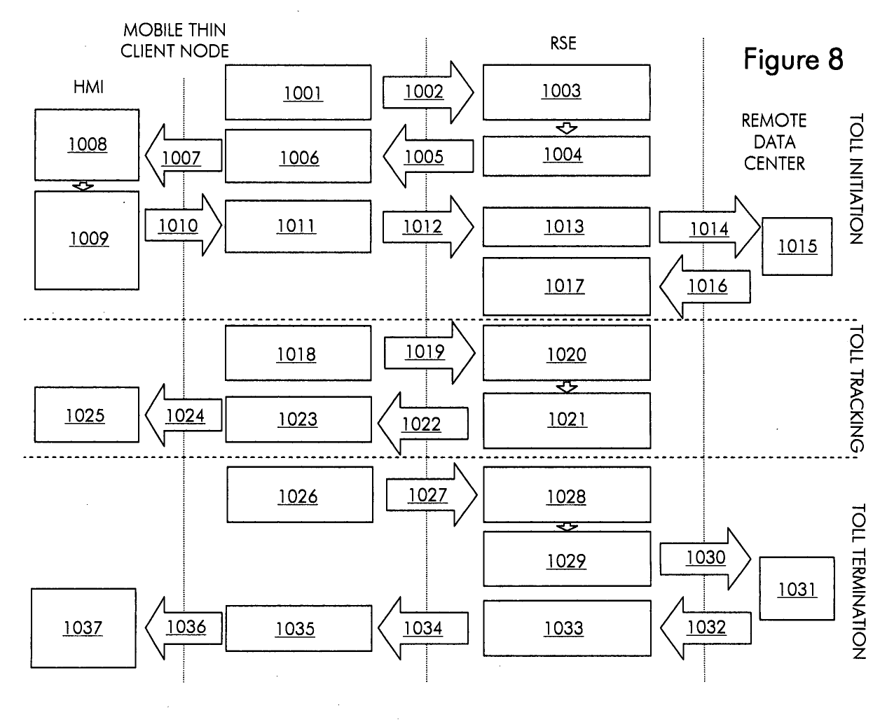

FIG. 8 shows a high occupancy toll (HOT) lane tolling application method operative in some embodiments of the invention. In this method, RSE 500 is installed on an HOT lane tolling application node at roadside and includes a HOT lane tolling application executable by a processing element, such as application server 501. The method involves toll initiation, toll tracking and toll termination. Toll initiation begins when one of mobile thin client nodes 300 broadcasts its geoposition (1002) on the local network (1001). RSE 500 receives the geoposition, estimates the vehicle position and matches it to the map with preferably lane level accuracy (1003). RSE 500 determines if the vehicle must be tolled (1004), and if tolling is required, broadcasts a tolling ID request (1005) on the local network. The mobile thin client node receives the tolling ID request and requests driver approval to send the thin client tolling ID (1006). The mobile thin client node sends the approval request (1007) to HMI 422. HMI 422 receives the approval request (1007) and provides a sensory alert to notify driver 424 of the lane tolling status (1008). Driver 424 provides sensory input to HMI 422 to denote toll approval unless auto-acknowledge is enabled (1009). HMI 422 then sends approval granted information (1010). The mobile thin client node retrieves and then transmits the thin client tolling ID (1011) and broadcasts the tolling ID information (1012) onto the local network. RSE 500 receives the tolling ID information (1012) and RSE 500 requests validation of the thin client tolling ID (1013) and broadcasts the request tolling ID validation information (1014) onto the backhaul network to remote fixed nodes 311. A remote data center installed on remote fixed nodes 311 receives the request tolling ID validation information (1014), validates the tolling ID (1015) and broadcasts the tolling ID validation information (1016) onto the backhaul network. RSE 500 receives the tolling validation information (1016) and associates the tolling ID with the vehicle and initiates a tolling track for the vehicle (1017). Toll tracking consists of a loop in which the mobile thin client node broadcasts the vehicle positioning information (1019) on the local network (1018). RSE 500 receives the positioning Information (1019) and estimates the vehicle position and matches it to the map with preferably lane level accuracy (1020). RSE 500 then associates the vehicle with the tolling track, updates the current toll based on the vehicle position (1021) and broadcasts the current toll amount (1022) on the local network. The mobile thin client node receives the current toll amount (1022) and passes the current toll amount (1024) to HMI 422 (1023). HMI 422 receives the current toll amount (1024) and provides sensory output of the current toll amount (1025). Toll termination begins when the mobile thin client node broadcasts the vehicle positioning information (1027) on the local network (1026). RSE 500 receives the position information (1027) and estimates the vehicle position and matches the position to the map with preferably lane level accuracy (1028). RSE 500 then associates the vehicle with the tolling track, determines that the vehicle has excited the toll lane (1029) and broadcasts the final toll amount (1030) onto the backhaul network. The remote data center receives the final toll amount (1030), adds the final toll to the driver's toll account (1031) and broadcast the billing confirmation (1032) onto the backhaul network. RSE 500 receives the billing confirmation (1032) and transmits the final toll amount and billing confirmation to the mobile thin client node (1033) by broadcasting the final confirmed toll (1034) on the local network. The mobile thin client node receives the final confirmed toll (1034) and passes the final confirmed toll (1036) to HMI 422 (1035). HMI 422 receives the final confirmed toll (1036) and provides sensory output of the final toll and billing confirmation (1037).

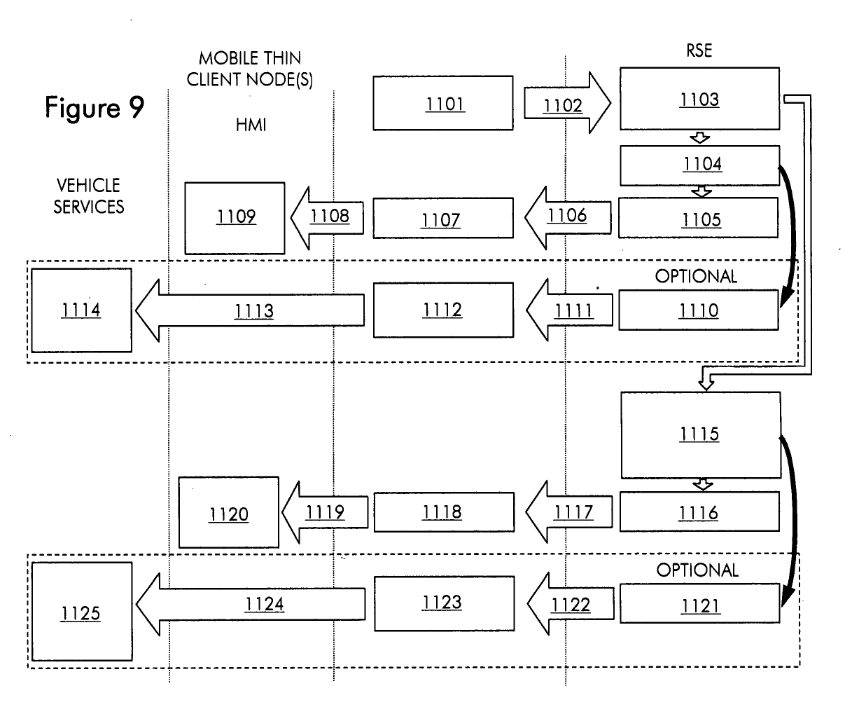

FIG. 9 shows an intersection safety application method. In this method, RSE 500 is installed on an intersection safety application node at roadside and includes an intersection safety application executable by a processing element, such as application server 501. One of mobile thin client nodes 300 broadcasts vehicle positioning information (1101) on the local network. The positioning information (1102) is transmitted to RSE 500, which estimates the vehicle position and matches it to the intersection map preferably with lane level accuracy (1103). RSE 500 determines if the mobile thin client node is in danger of collision (1104) and notifies any vehicles in danger of collision (1105). A collision warning message (1106) is transmitted from RSE 500 and delivered to the mobile thin client node. The mobile thin client node passes the collision warning to HMI 422 (1107) which provides sensory alert to notify driver 424 of a possible collision (1109). Optionally, when RSE 500 determines if vehicles are in danger of collision (1104), RSE 500 determines an appropriate collision avoidance maneuver (1110) and transmits an avoidance maneuver command (1111) to the mobile thin client node which passes the collision avoidance command to vehicle services 417 (1112). When the avoidance maneuver reaches vehicle services 417 (1113) a control system automatically executes the collision avoidance maneuver (1114). In addition to determining if the vehicle is in danger and issuing an alert, RSE 500 also determines if the vehicle is in danger of violating an traffic signal based on vehicle position, trajectory and current signal state and phase (1115). RSE 500 notifies all vehicles in danger of a signal violation (1116) sending a signal violation warning (1117) to appropriate mobile thin client nodes. The mobile thin client node receives the signal violation warning and passes the signal violation warning to HMI 422 (1118). The signal violation warning reaches HMI 422 (1119) and provides sensory alert to notify the driver of a possible signal violation (1120). Attendant to determining if the vehicle is in danger of violating the traffic signal (1115), RSE 500 can optionally determine an appropriate signal violation avoidance maneuver (1121). RSE 500 can subsequently transmit an avoidance maneuver command to the mobile thin client node (1122). The mobile thin client node receives the command and upon receipt sends the command to vehicle services 417 (1123). The avoidance maneuver command is received by vehicle services 417 (1124) and the control system automatically executes a signal violation avoidance maneuver (1125).

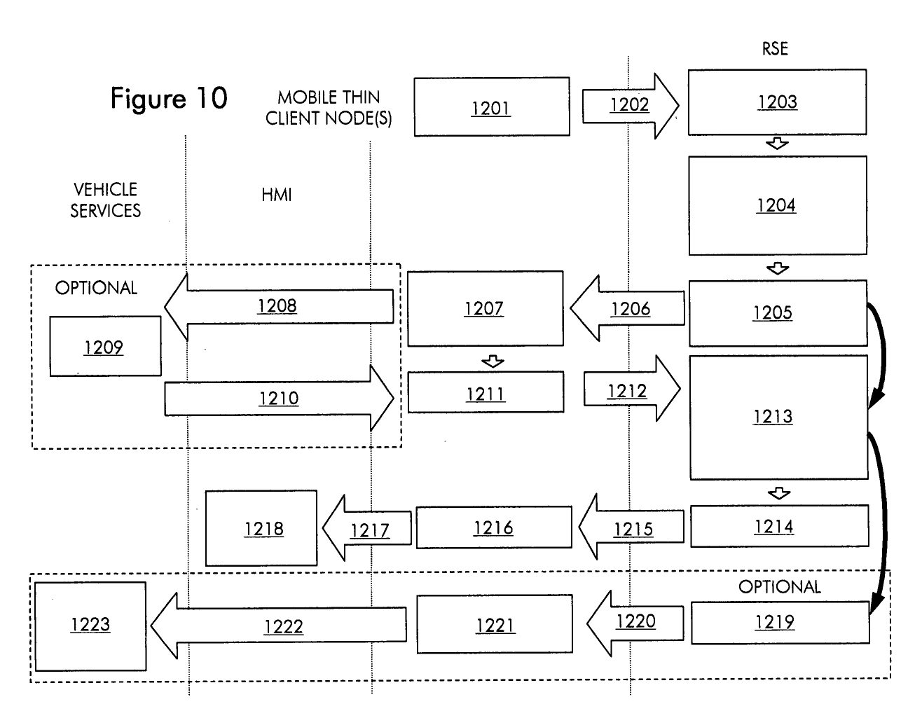

FIG. 10 shows a curve safety application method. In this method, RSE 500 is installed on a roadside curve safety application node at roadside and includes a roadside curve safety application executable by a processing element, such as application server 501. Curve safety begins when one of mobile thin client nodes 300 broadcasts vehicle positioning information (1202) on the local network (1201). RSE 500 receives the positioning information (1202), estimates the vehicle position and matches it to the local road map with preferably lane level accuracy (1203). RSE 500, based on current road conditions and the vehicle trajectory, determines if the vehicle may be in danger on the curve (1204). If the vehicle performance envelope or the performance envelope ID is known at RSE 500, then based on the current road conditions, vehicle position, vehicle trajectory and the vehicle performance envelope, RSE 500 determines if the vehicle is in danger on the curve (1213). If the performance envelope is not known then RSE 500 generates a performance envelope request (1205) which is broadcast on the local network (1206). The mobile thin client node receives the performance envelope request (1206) and retrieves the locally stored performance envelope of the vehicle. Optionally, if the performance envelope of the vehicle is not stored locally, the performance envelope request (1208) is passed to vehicle services 417 (1207). If appropriate, vehicle services 417 receive the performance envelope request (1208), retrieve the vehicle performance envelope (1209) and pass the performance envelope information (1210) to other mobile thin client node elements. In both cases, the performance envelope information (1212) is transmitted (1211) by the mobile thin client node by broadcasting them on the local network. RSE 500 receives the performance envelope information (1212) and based on current road conditions, vehicle position, vehicle trajectory and the vehicle performance envelope, determines if the vehicle is in danger on the curve (1213). RSE 500 then transmits the curve-overspeed warning information (1215) by broadcasting it onto the local network (1214). The mobile thin client node receives the overspeed warning information (1215) and passes the curve-overspeed warning (1217) to HMI 422 (1216). HMI 422 provides sensory alert to notify driver 424 of curve-overspeed (1218). Optionally, RSE 500 can determine the safe curve speed (1219) and broadcast the safe curve speed information (1220) onto the local network. The mobile thin client node receives the safe curve speed information (1220) and passes the safe curve speed information (1222) to vehicle services 417 (1221) where a control system automatically reduces the vehicle speed to a safe curve speed (1223).

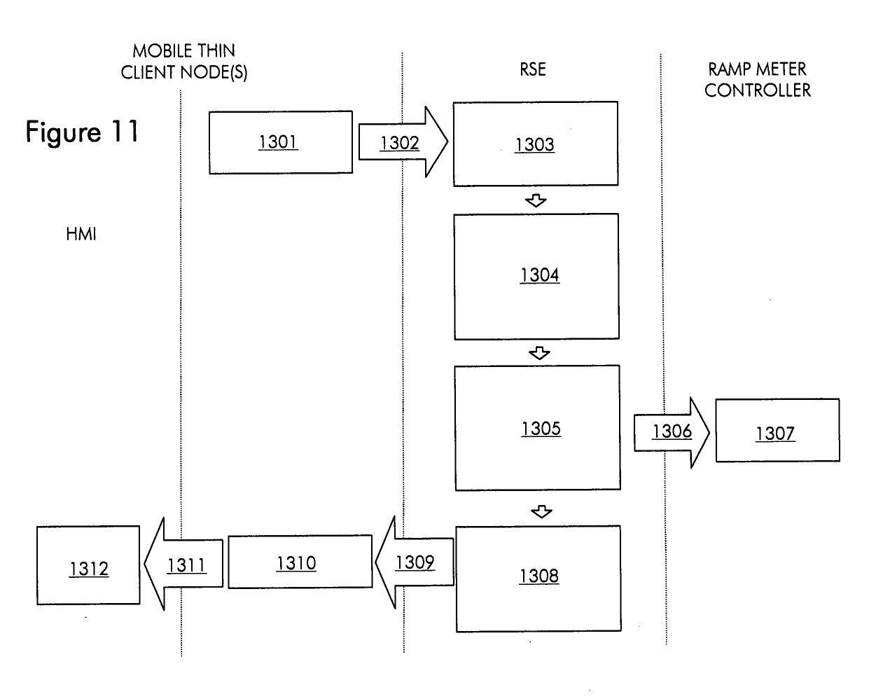

FIG. 11 shows a ramp meter application method. In this method, RSE 500 is installed on a ramp meter application node at roadside and includes a ramp meter application executable by a processing element, such as application server 501. One of thin client nodes 300 broadcasts vehicle positioning information onto the local network (1301). The positioning information is received by RSE 500 (1302) from a mobile thin client node and vehicle position is estimated and matched to the local road and ramp map preferably with lane level accuracy (1303). RSE 500 then estimates vehicle spacing on the merge lane based on vehicle speeds on the merge lane (1304). Additionally, RSE 500 estimates ramp depth based on vehicle positions on the on-ramp (1304). RSE 500 then computes the ramp meter timing to maximize roadway efficiency based on estimated merge lane speeds and estimated ramp depth (1305). RSE 500 estimates ramp meter delay information for queued vehicles based on ramp meter timing and vehicle position (1308). RSE 500 issues the ramp delay estimate to the mobile thin client node (1309) which passes the ramp delay estimate to HMI 422 (1310). The ramp delay estimate reaches HMI 422 (1311) and provides sensory output of the ramp delay estimate to driver 424 (1312).

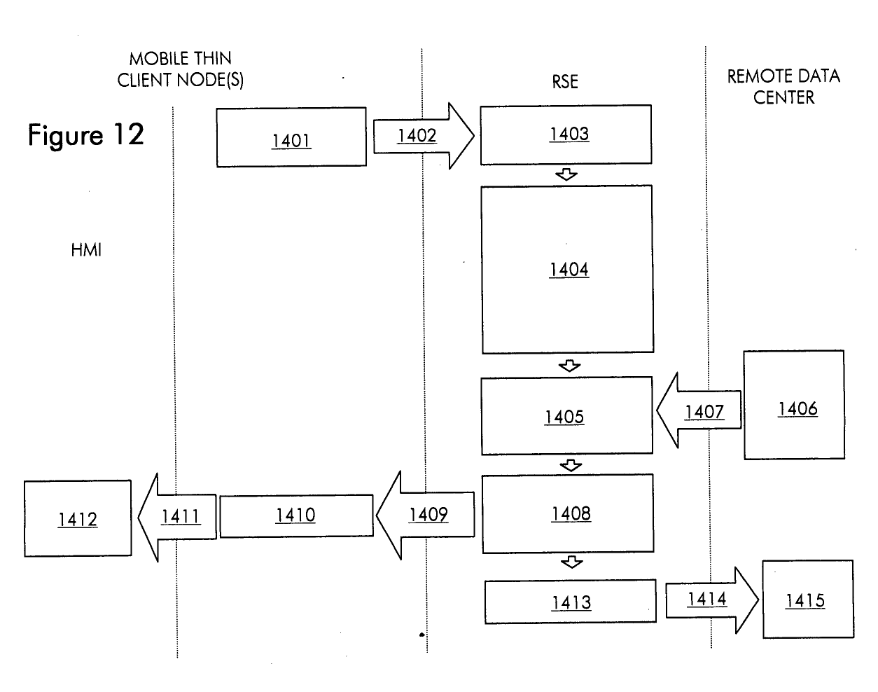

FIG. 12 shows a traveler advisement application method. In this method, RSE 500 is installed on a traveler advisement application node at roadside and includes a traveler advisement application executable by a processing element, such as application server 501. The method begins when one of mobile thin client nodes 300 broadcasts vehicle position information (1402) on the local network (1401). RSE 500 estimates the vehicle position and matches it to the map with preferably lone level accuracy (1403). RSE 500 then computes the real-time local traveler information based on vehicle positions and speeds in the local network, preferably including 1) local estimated traffic, 2) local detected incidents, 3) In vehicle signage, 4) local road topology (1404). Through the backhaul network, a remote data center transmits traveler information (1407) computed at the remote data center (1406) which augments local traveler information (1405). RSE 500 then generates and broadcasts vehicle specific traveler information (1409), preferably tailored for HMI 422 (1408), on the local network. The mobile thin client node receives the vehicle specific traveler information (1409) and passes the vehicle specific traveler information (1411) to HMI 422 (1410), which provides a sensory alert to notify driver 422 of the traveler information (1412). RSE 500 can also transmit local traveler information (1414) to a remote data center (1413) through the backhaul network. The remote data center can then update the current traveler information (1415).

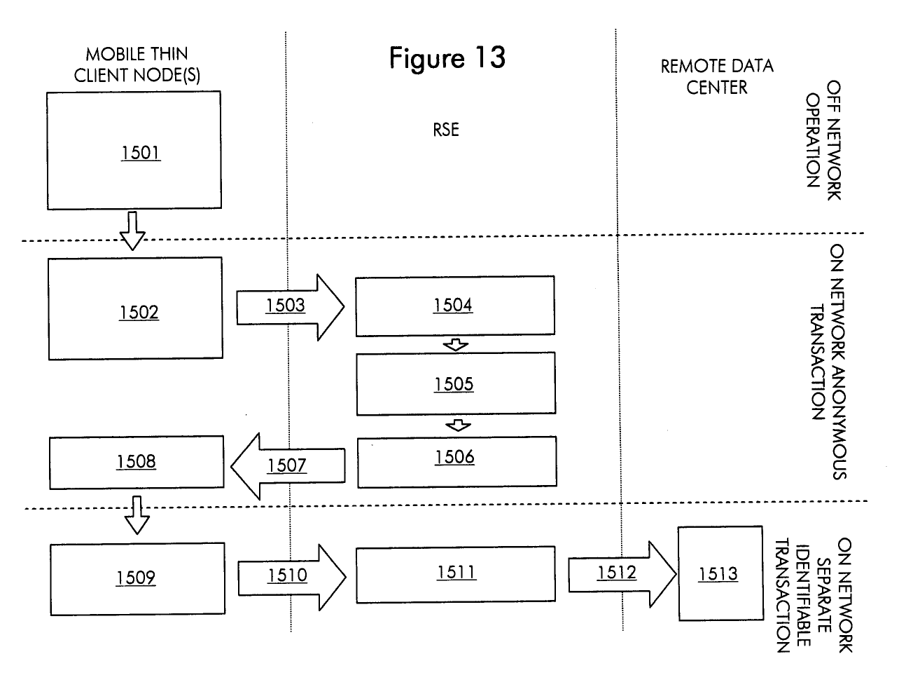

FIG. 13 shows a progressive insurance application method. In this method, RSE 500 is installed on a progressive insurance application node at roadside and includes a progressive insurance application executable by a processing element, such as application server 501. One of mobile thin client nodes 300 locally stores vehicle positioning and time information (e.g. vehicle track information) when not connected to the progressive insurance server (1501). When connected to a progressive insurance server on the local network, the mobile thin client node retrieves the vehicle track information from storage and transmits the vehicle track information to the progressive insurance server in an anonymous transaction (1502). RSE 500 receives the anonymous track information (1503) and estimates the vehicle track and matches it to a map preferably with lane level accuracy (1503). RSE 500 computes driver metrics based on anonymous vehicle track information (1505) and transmits the driver metrics back to the mobile thin client node (1506). The driver metrics are received by the mobile thin client node (1507) and locally applied to update cumulative driver metrics (1508). When connected to a progressive insurance server on the local network, the mobile thin client node retrieves the driver metric data from storage and transmits the driver metric data to the progressive insurance server in an identifiable transaction (1509). RSE 500 receives the identifiable driver metrics (1510) and the progressive insurance server passes the driver metrics over a backhaul network to the insurance company data center (1511). The driver metrics are received by the insurance company data center (1512) and used to update a driver profile (1513), which may be used by the insurance company to compute an insurance rate for driver 424.

Where not otherwise specified, functional elements of the methods and systems described herein may generally perform their respective roles using any combination of hardwired logic and software. It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for intelligent traffic management, comprising the steps of:
receiving Global Navigation Satellite System (GNSS) signals on a mobile client node;
determining position information on the mobile client node based at least in part on the GNSS signals;
transmitting the position information to a roadside system;
determining on the roadside system a road position of the mobile client node based at least in part on the position information and geospatial roadmap data stored on the roadside system; and
generating an application result based at least in part on the road position.

2. The method of claim 1, further comprising the step of transmitting the application result to the mobile client node.

3. The method of claim 1, further comprising the step of transmitting the application result to a local traffic management node.

4. The method of claim 1, wherein the position information comprises a geoposition.

6. The method of claim 1, wherein the step of generating an application result comprises generating tolling information.

7. The method of claim 1, wherein the step of generating an application result comprises generating intersection safety information.

8. The method of claim 1, wherein the step of generating an application result comprises generating curve safety information.

9. The method of claim 1, wherein the step of generating an application result comprises generating ramp metering information.

10. The method of claim 1, wherein the step of generating an application result comprises generating traveler advisement information.

11. The method of claim 1, wherein the step of generating an application result comprises generating insurance rate information

12. The method of claim 2, wherein the step of transmitting an application result comprises transmitting a driver warning.

13. The method of claim 2, wherein the step of transmitting an application result comprises transmitting a vehicle maneuver command.

14. The method of claim 2, wherein the step of transmitting an application result comprises transmitting information adopted for use in a system integrity check.

15. The method of claim 2, wherein the step of transmitting an application result comprises transmitting tolling information.

16. The method of claim 2, wherein the step of transmitting an application result comprises transmitting advertising information.

17. A thin client intelligent transportation system, comprising:
at least one mobile client node;
a roadside system comprising at least one roadside node; and
a wireless network communicatively coupling the mobile client node and the roadside system, wherein the mobile client node is adopted to transmit position information to the roadside system via the wireless network, receive an application result from the roadside system generated based at least in part on the position information and geospatial roadmap data stored on the roadside system and take action based at least in part on the application result.

18. A roadside system, comprising:
a wireless communication interface;
a geospatial roadmap database; and
a processing element communicatively coupled with the wireless communication interface and the geospatial roadmap database, wherein the processing element is adapted to determine a road position of a mobile client node based at least in part on position information received from the mobile client node via the wireless communication interface and geospatial roadmap data from the geospatial roadmap database.

19. The roadside system of claim 18, wherein processing element is further adapted to transmit to the mobile client node via the wireless communication interface an application result generated based at least in part on the road position.

20. The roadside system of claim 18, wherein roadside system further comprises a second communication interface adapted to communicatively couple the roadside system with a local traffic management system and the processing element is further adapted to transmit to the local traffic management system an application result generated based at least in part on the position.

21. The roadside system of claim 18, wherein roadside system further comprises a second communication interface adapted to communicatively couple the roadside system with a local traffic management system and the processing element is further adapted to generate an application result based at least in part on information received via the second communication interface from the local traffic management system.

22. The roadside system of claim 18, wherein the roadside system further comprises a third communication interface adapted to communicatively couple the roadside system with a remote data center and the processing element is further adapted to transmit to the remote data center the position for processing at the remote data center.

23. The roadside system of claim 22, wherein the remote data center is adapted to transmit to the roadside system via the third communication interface an update to at least one of the geospatial roadmap database or map matching software executable by the processing element.

24. The roadside system of claim 18, further comprising a GNSS receiver wherein the processing element is adapted to determine the road position based further in part on position information received from the GNSS receiver.

25. A mobile client node, comprising:
a GNSS receiver;
a wireless communication interface; and
a processing element communicatively coupled with the GNSS receiver and the wireless communication interface, wherein the processing element is adapted to determine position information based at least in part on information received from the GNSS receiver and transmit the position information to a roadside system via the wireless communication interface, and in response to the position information receive an application result from the roadside system via the wireless communication interface.
